(19) United States
(12) Patent Application Publication
(10) Pub. No.: US 2024/0314722 A1
(43) Pub. Date: Sep. 19, 2024

(54) TIMING-BASED POSITIONING VIA A REPEATER

(71) Applicant: QUALCOMM Incorporated, San Diego, CA (US)

(72) Inventors: Navid ABEDINI, Basking Ridge, NJ (US); Sony AKKARAKARAN, Poway, CA (US)

(21) Appl. No.: 18/183,101

(22) Filed: Mar. 13, 2023

(51) Int. Cl. H04W 64/00; H04L 5/00

(52) U.S. Cl. CPC H04W 64/00; H04L 5/0048

(57) ABSTRACT

In an aspect, a network entity may obtain an indication of whether a mobile termination node of a repeater and a forwarding node of the repeater are co-located. The network entity may obtain, based on the indication, location information indicative of a location of at least one of the mobile termination node or the forwarding node. The network entity may obtain timing information associated with the repeater. The network node may provide, for a network node, a request to transmit a set of reference signals or to perform a set of measurements for a positioning session based on the location information and the timing information.

### TECHNICAL FIELD

The present disclosure relates generally to positioning systems, and more particularly, to positioning systems involving a repeater.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at network entity are provided. The apparatus may include memory and at least one processor coupled to the memory. The at least one processor, based at least in part on information stored in the memory may be configured to obtain an indication of whether a mobile termination node of a repeater and a forwarding node of the repeater are co-located, obtain, based on the indication, location information indicative of a location of at least one of the mobile termination node or the forwarding node, obtain timing information associated with the repeater, and provide, for a network node, a request to transmit a set of reference signals or to perform a set of measurements for a positioning session based on the location information and the timing information.

In another aspect of the disclosure, a method, a computer-readable medium, and an apparatus at a network node are provided. The apparatus may include memory and at least one processor coupled to the memory. The at least one processor, based at least in part on information stored in the memory may be configured to obtain an indication of whether a mobile termination node of a repeater and a forwarding node of the repeater are co-located, provide at least one of an identifier (ID) of the mobile termination node or location information indicative of a location of the forwarding node, provide timing information associated with the repeater, and receive a request to transmit a set of reference signals or perform a set of measurements for a positioning session based on the location information and the timing information.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating a repeater in accordance with various aspects of the present disclosure.

FIG. 6 is a diagram illustrating an over-the-air timing synchronization-based technique for estimating the backhaul propagation delay at a distributed unit of a base station in accordance with various aspects of the present disclosure.

FIG. 7 is a call flow diagram illustrating a method of wireless communication in accordance with various aspects of this present disclosure.

FIG. 8 is a call flow diagram illustrating a method of wireless communication in accordance with various aspects of this present disclosure.

FIG. 9 is a flowchart illustrating methods of wireless communication in accordance with various aspects of the present disclosure.

FIG. 10 is a flowchart illustrating methods of wireless communication in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

Various aspects relate generally to positioning systems. Some aspects more specifically relate to timing-based positioning based on reference signals transmitted by a repeater. In some examples, a network entity (e.g., a location management function (LMF)) may obtain location information associated with a repeater (e.g., the location of a mobile termination node and/or a forwarding node of the repeater). The network entity may also obtain timing information associated with the repeater (e.g., a backhaul propagation delay and/or an internal delay of the repeater). The network entity may, based on the location information and the timing information, provide a request (e.g., to the network node) to transmit a set of reference signals or a request (e.g., to a UE) to perform a set of measurements for a positioning session.

Particular aspects of the subject matter described in this disclosure can be implemented to realize one or more of the following potential advantages. In some examples, by considering the location and timing information of a repeater when performing the positioning session, a more accurate positioning result or state (e.g., the location, heading, and/or velocity) of a target entity may be determined.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

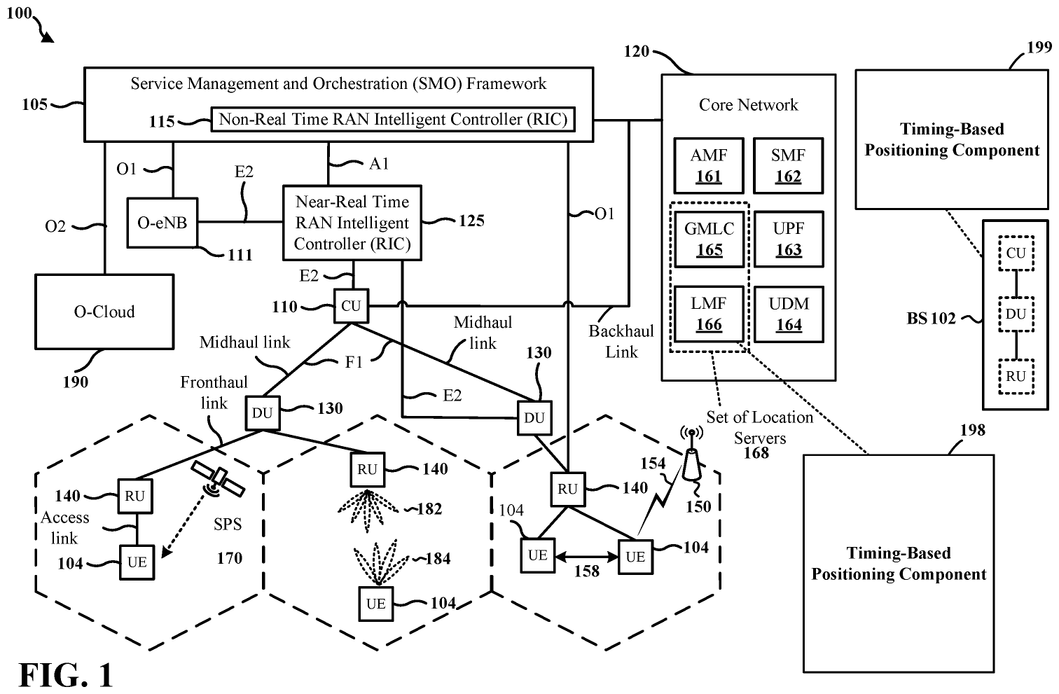

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR2-2 (52.6 GHZ-71 GHZ), FR4 (71 GHZ-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the LMF 166 may have a timing-based positioning component 198 that may be configured to obtain an indication of whether a mobile termination node of a repeater and a forwarding node of the repeater are co-located, obtain, based on the indication, location information indicative of a location of at least one of the mobile termination node or the forwarding node, obtain timing information associated with the repeater, and provide, for a network node, a request to transmit a set of reference signals or to perform a set of measurements for a positioning session based on the location information and the timing information. In certain aspects, the base station 102 may have a timing-based positioning component 199 that may be configured to obtain an indication of whether a mobile termination node of a repeater and a forwarding node of the repeater are co-located, providing at least one of an ID of the mobile termination node or location information indicative of a location of the forwarding node, provide timing information associated with the repeater, and receive a request to transmit a set of reference signals or perform a set of measurements for a positioning session based on the location information and the timing information.

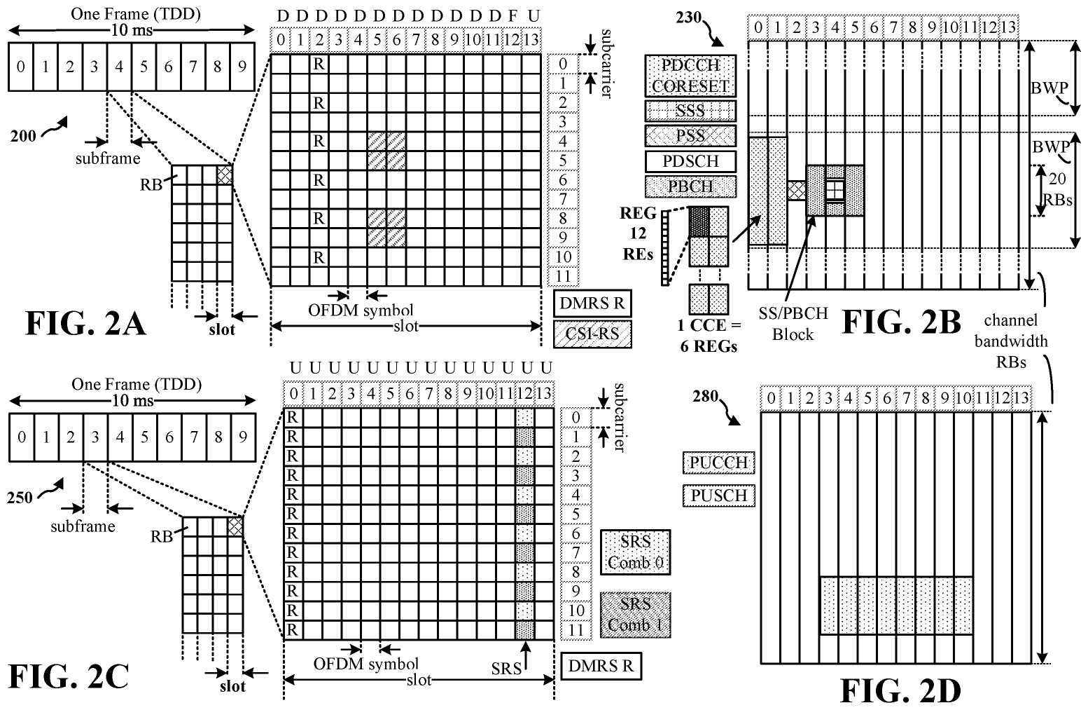

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology u=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

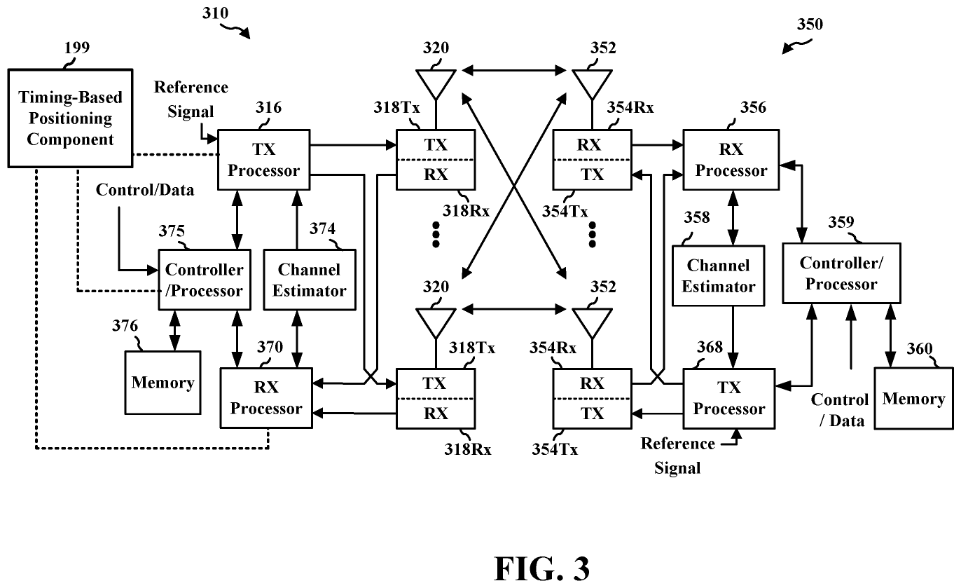

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 316, the RX processor 370, and the controller/processor 375 may be configured to perform aspects in connection with the timing-based positioning component 199 of FIG. 1.

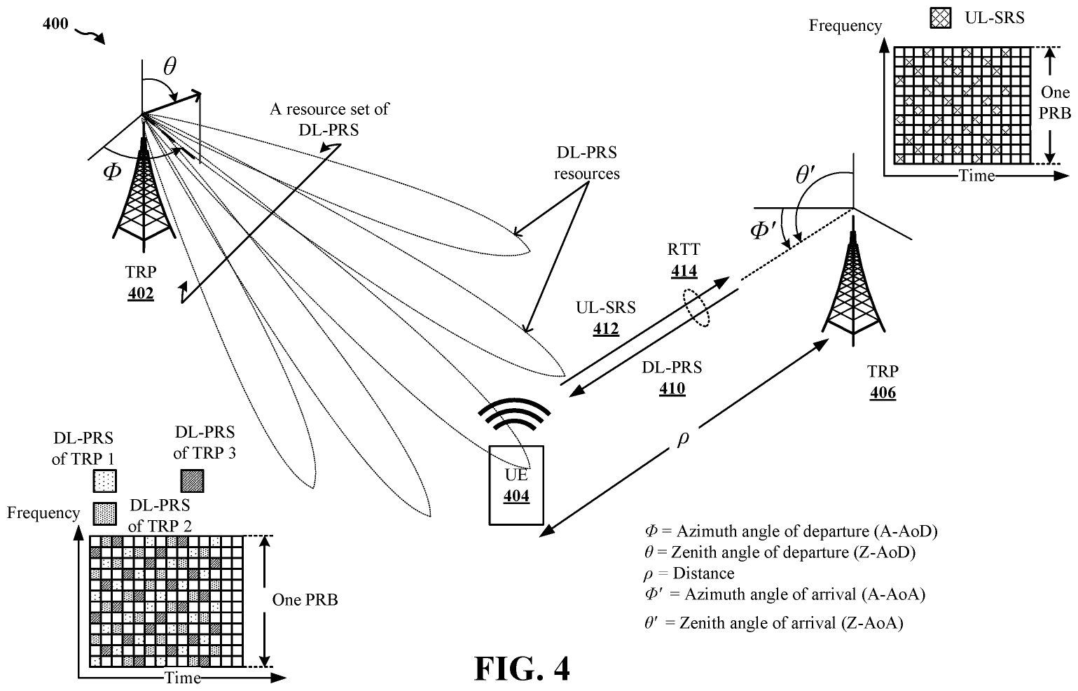

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}-T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

For purposes of the present disclosure, a positioning session may be referred to the transmitting, the receiving, and the measuring of reference signals for the purposes of determining a positioning result or state (e.g., a location, a heading, a velocity, etc.) of a target entity. A target entity may be any object (e.g., a person, a vehicle, a UE, etc.) for which a positioning session is performed, for example, to determine a location thereof, a velocity thereof, a heading thereof, etc.

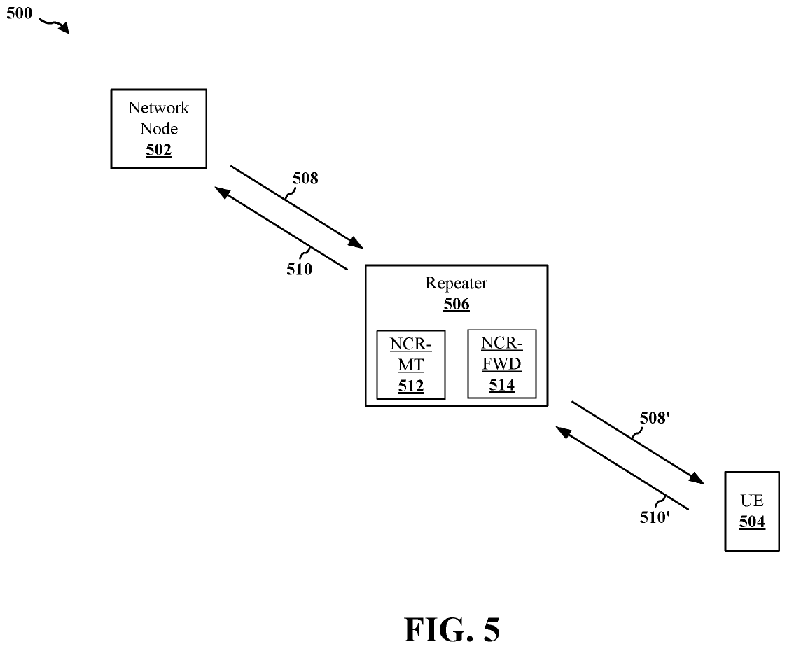

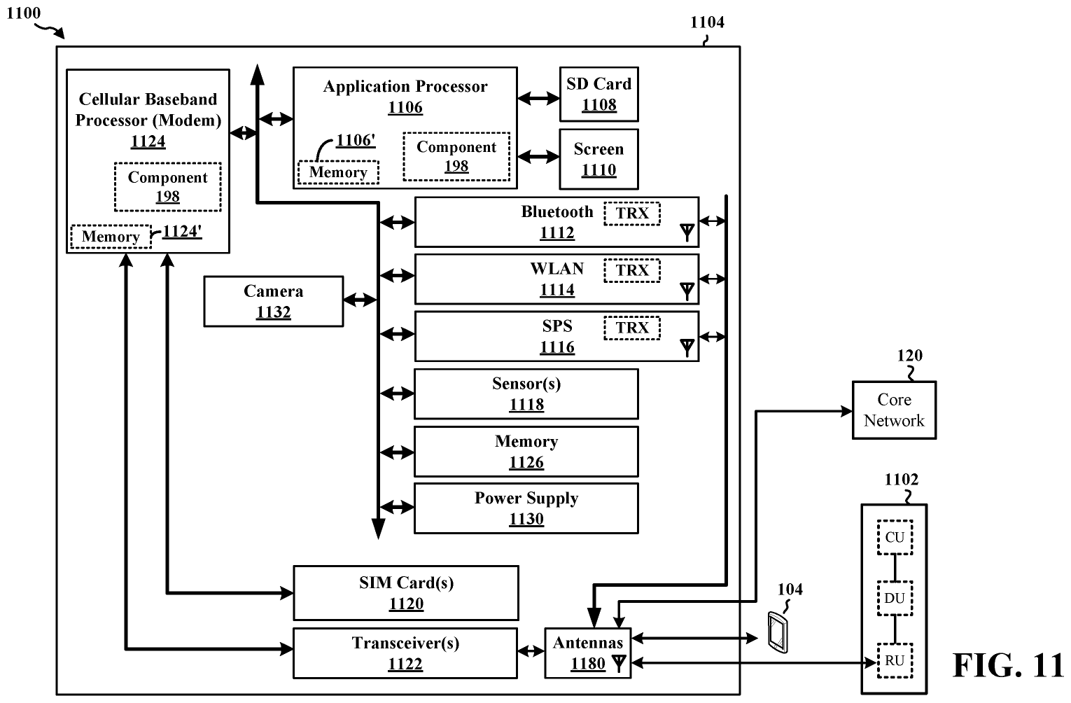

A repeater (e.g., a network-controlled repeater (NCR)) may be used to forward positioning references used for positioning of a remote UE. For example, FIG. 5 is a diagram 500 illustrating a repeater 506 in accordance with various aspects of the present disclosure. As shown in FIG. 5, the repeater 506 may include a mobile termination node (NCR-MT) 512 and a forwarding node (NCR-FWD) 514. The mobile termination node 512 may be a component of the repeater 506 that maintains the control link (C-link) between a network node 502 and the repeater 506 to enable information exchanges (e.g., side control information). The mobile termination node 512 may include a communication interface (e.g., a modem, such as the cellular baseband processor 1124 described with reference to FIG. 11) by which the network node 502 may control and/or configure the repeater 506, e.g., via commands or control information provided via the communication interface. The mobile termination node 512 may also support NR-based positioning. The forwarding node 514 may be a component of the repeater 506 that maintains a backhaul link between the network node 502 and the repeater 506 and an access link between the repeater 506 and the UE 504. The forwarding node 514 may include a plurality of antennas, such as antenna elements, antenna panels, and/or antenna arrays, for transmitting and receiving RF signals. In some aspects, the mobile termination node 512 and the forwarding node 514 may be co-located. For example, the mobile termination node 512 and the forwarding node 514 may be included within a same device housing. In another example, the mobile termination node 512 and the forwarding node 514 may be located within the same room. In other aspects, the mobile termination node 512 and the forwarding node 514 may not be co-located. For example, the mobile termination node 512 and the forwarding node 514 may be included in different device housings. In another example, the mobile termination node 512 may be located on a first floor of a building, and the forwarding node 514 may be located on a second floor of the building. The forwarding node 514 may receive downlink signals 508 from a network node 502 and forward the downlink signals (shown as downlink signals 508′) to a remote UE 504. Similarly, the forwarding node 514 may receive uplink signals 510 from the remote UE 504 and forward the uplink signals (shown as signals 510′) to the network node 502. While the repeater 506 just forwards the downlink signals 508 (e.g., with no or minimal processing), and hence the network node 502 (e.g., a gNB) may be the logical source/destination of downlink/uplink signals, the repeater 506 may be considered as the physical source/destination for positioning purposes.

For positioning, the physical location of the repeater may be utilized and considered. For timing-based positioning, where the RTT or time of arrival is utilized, the signals forwarded by the repeater may have additional delay components that should be considered. One type of delay is the backhaul (BH) propagation delay between the network node and the repeater (e.g., the amount of time for a signal to be received by the repeater after being transmitted from the network node (or a UE)). Another type of delay is the internal delay of the repeater (e.g., the amount of time it takes the repeater to transmit (or forward) a received signal). Aspects of the present disclosure are directed to techniques for utilizing such delays for timing-based positioning.

In some aspects, assuming that the mobile termination node (e.g., the mobile termination node 512) is co-located with the forwarding node (i.e., the antennas of the forwarding node 514) and also supports NR-based positioning, the position (or physical location) of the mobile termination node may be acquired and utilized as the position of the repeater (e.g., the repeater 506). For instance, a network entity (e.g., the LMF 166) may initiate a request for the position of the mobile termination node. The request may be provided to another network entity (e.g., another LMF) that maintains the position of the mobile termination node or may be provided directly to the mobile termination node. In a scenario in which the LMF 166 stores the position of the mobile termination node in a memory and/or cache of the LMF 166 (e.g., after obtaining it from another network entity or the mobile termination node), the LMF 166 may retrieve the position therefrom. The entity to which the request is sent (e.g., another LMF or the mobile termination node) may provide a response that includes the location information.

The LMF 166 may identify the mobile termination node in the request via an identifier. The identifier may be a general public subscription identifier (GPSI) associated with the mobile termination node. The mobile termination node may share its GPSI with a network node (e.g., the CU 110 and/or DU 130 of a base station, such as the network node 502) using a medium access control-control element (MAC-CE) or RRC signaling. The network node may include the GPSI of the mobile termination node in a TRP information message of the repeater. The TRP information message may be provided to the LMF 166, and the LMF 166 may obtain the GPSI of the repeater from the TRP information message. In some aspects, the location information element (IE) in the TRP information message may be left blank (or empty) when the network node sends the message to the LMF 166.

In a scenario in which the mobile termination node and the forwarding node (i.e., the antennas of the forwarding node) are not co-located, the network (e.g., the LMF 166, the CU 110, or the DU 130) may be notified that the mobile termination node and the forwarding node are not co-located. The network may also be notified of the location and/or orientation of the antennas of the forwarding node. That is, the location and/or orientation of the antennas of the forwarding node may be indicated with reference to the mobile termination node. In the event that the LMF 166 is notified of such information, the LMF 166 may be notified by an operations, administration, and management (OAM) (e.g., an OAM server or node). The OAM may be managed by a cellular service provider. The OAM may include processes, activities, tools, and standards utilized for operating, administering, managing and maintaining IAB nodes. In the event that a network node is notified of such information, the network node may be notified by the repeater or the OAM node. That is, this information may be initially provided by the repeater or its OAM (e.g., to the network node) and may further be shared between different network nodes (e.g., the CU 110, the DU 130, and/or the LMF 166).

In some aspects, the BH propagation delay may be determined (e.g., calculated) given a line-of-sight (LOS) assumption between the repeater and the network node (if valid) and the repeater's known location. That is, if the location of the repeater and the location of the network node (e.g., the gNB) is known and assuming there is an LOS therebetween, the propagation delay between the repeater and the network node may be calculated based on a time at which the network node transmits a reference signal to the repeater and a time at which the repeater receives the reference signal. The BH propagation delay may calculated by the LMF 166. The LOS/non-LOS (nLOS) may be estimated by the DU 130 using UL-SRS based measurements. The repeater or the OAM node may report an LOS indication (i.e., an indication as to whether there is an LOS between the network node and the repeater) (if this information is available at the time of deployment). The LOS indication may be provided to the network node, which in turn, may provide the LOS indication to the LMF 166.

Alternatively, the BH propagation delay may be acquired via NR positioning of the mobile termination node (e.g., using RTT estimation, which is two times the BH propagation delay). That is, the LMF 166 may receive a set of RTT measurements between the mobile termination node and the network node when determining the location of the mobile termination node. The LMF 166 may calculate the BH propagation delay based on the set of RTT measurements.

In yet a further alternative, the mobile termination node or the network node (e.g., the DU 130) may locally estimate the BH propagation delay (e.g., using a timing advance (TA) value and a Tdelta value associated with an IAB node). For example, downlink transmit timing and the uplink receive timing may not be aligned and, as a result, there can be a misalignment gap T (also referred to as Tdelta, which represents a timing offset between the downlink transmit signal and an uplink receive signal). In some cases, it can be beneficial for a child IAB node to properly set its downlink transmit timing for over-the-air (OTA) based timing and synchronization. In such cases, the misalignment gap T may be signaled from the parent IAB node of the child IAB node

This OTA timing synchronization technique may be leveraged to locally estimate the BH propagation delay at the mobile termination node or the DU 130. For instance, the DU 130 (also referred to as a donor DU) may indicate its Tdelta value to the mobile termination node (e.g., via a MAC-CE message). The mobile termination node may utilize the Tdelta value to estimate the BH propagation delay and provide the estimated BH propagation delay to the donor DU. The mobile termination node may report its estimate (e.g., via a MAC-CE message) to the DU. The DU may include the BH propagation delay estimate in a TRP information message and exchange the message with the CU 110 or the LMF 166.

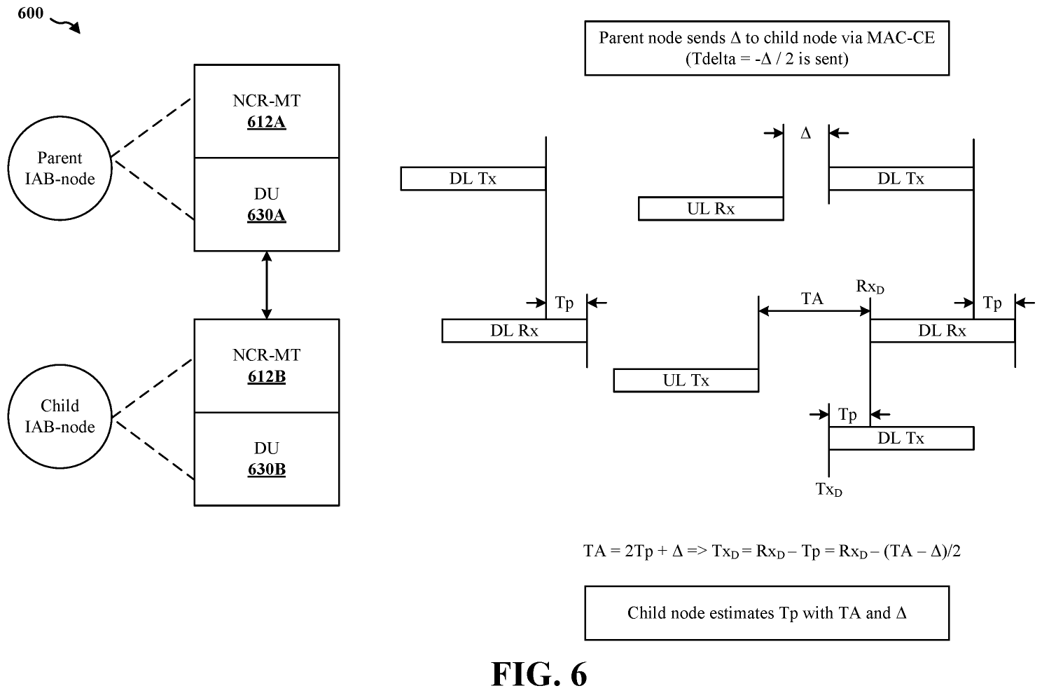

For example, FIG. 6 is a diagram 600 illustrating an OTA timing synchronization-based technique for estimating the BH propagation delay at a DU in accordance with various aspects of the present disclosure. As shown in FIG. 6, a first mobile termination node 612A and a first DU 630A may serve as a parent IAB-node, and a second mobile termination node 612B and a second DU 630B may serve as a child IAB-node, or vice versa. The first DU 630A may include a delay or delta (4) between the uplink receive timing (UL Rx) and the downlink transmit timing (DL Tx), and a timing advance (TA) between the uplink transmit timing (UL Tx) and the downlink receive timing (DL Rx). The first DU 630A may determine the Tdelta value in accordance with Equation 1, which is provided below:

$$Tdelta = - Δ / 2 \qquad ( Equation 1 )$$

The first DU 630A may provide the Tdelta value to the second mobile termination node 612B, for example, via a MAC-CE message. The second mobile termination node 612B may estimate the BH propagation delay (Tp) based on the Tdelta value, the delay (4), and/or the TA value, along with other measurements (e.g., RTT measurements). The second mobile termination node 612B may report its BH propagation delay to the first DU 630A, for example, via a MAC-CE message.

An error margin or uncertainty level may also be indicated (e.g., from the mobile termination node to the DU 130 and/or by the DU 130 to the CU 110/LMF 166). The error margin or uncertainty level may be indicative of a confidence level of the estimated BH propagation delay. The error margin or uncertainty level may, for example, depend on the SCS, the level of RSRP, the bandwidth used, and an amount averaging used in deriving the RTT estimate. For instance, a BH propagation delay associated with a relatively high error margin or uncertainty level may be given less weight, whereas a BH propagation delay associated with a relatively low error margin or uncertainty level may be given more weight. In some aspects, accuracy specifications may be defined for the mobile termination node to derive its RTT estimate within the indicated specifications (e.g., the estimation is to be accurate within a particular range of nanoseconds, etc.). The Tdelta value and RTT estimation may be different for different TRPs/beams, and therefore, signaling of such values may support the indication of multiple values (e.g., a Tdelta value and an RTT estimation on a per-TRP/beam basis).

The internal/group delay of the repeater may be known and reported by the repeater or OAM node. The report may be provided to any of the DU 130, the CU 110, or the LMF 166, and may be shared with other network entities, as needed.

In some non-typical deployments (e.g., when the repeater has multiple non-co-located access-side antenna delays), the group delay may be different for different access beams. That is, a group delay may be reported for each access beam.

In some aspects, a timing error group (TEG) IE may be utilized to address extra delays (e.g., the internal delay, the BH propagation delay, and/or a combination of these two delays) caused by a repeater. For example, a repeater may be associated with a particular TEG ID that identifies a particular TEG of the repeater. The TEG may be representative of transmit and receive timing errors associated with one or more reference signal resources, such as downlink-PRS resources, uplink-PRS/SRS resources, and sidelink PRS resources. The TEG may be associated with one or more different uplink, downlink and/or sidelink signals, and may include transmit and receive timing error values within a certain margin. For a given TEG ID associated with a repeater, the amount of mean error (in addition to the error margin values) for the TEG ID may be indicated, where the mean error captures the internal delay and/or BH propagation delay of the repeater. That is, the mean error may be an average of the internal delay and/or BH propagation delay of the repeater.

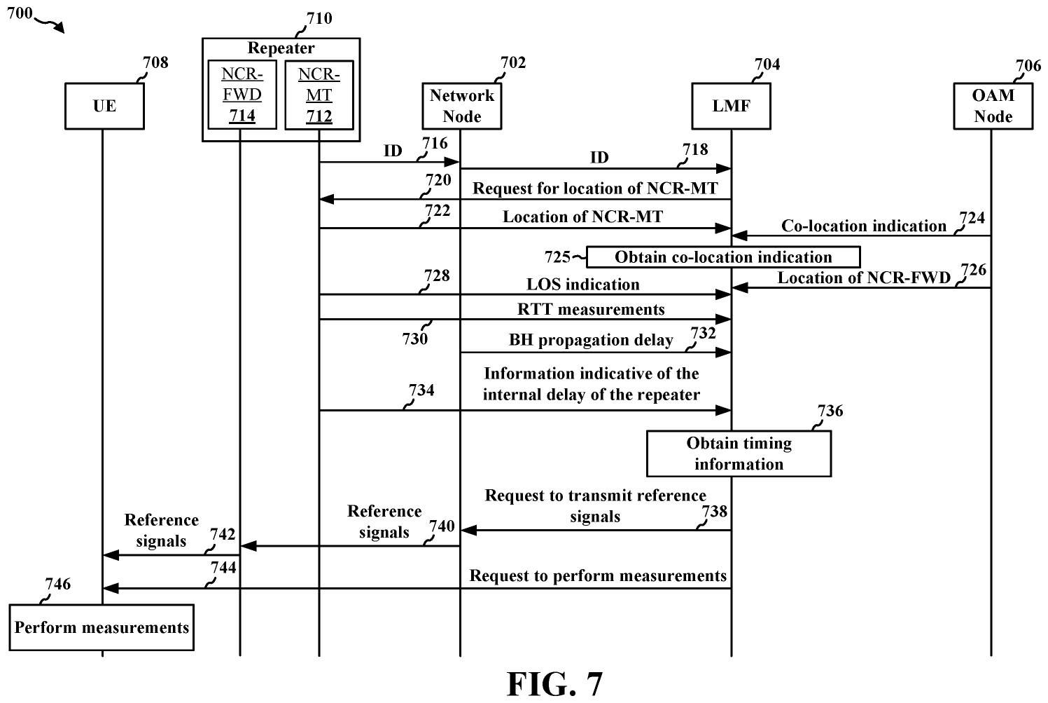

FIG. 7 is a call flow diagram illustrating a method of wireless communication in accordance with various aspects of the present disclosure. As shown in FIG. 7, the diagram 700 includes a network node 702, an LMF 704, an OAM node 706, a UE 708, and a repeater 710. The network node 702 may be an example of the base station 102, the base station 310, the TRP 402, the TRP 406, or the network node 502. The LMF 704 may be an example of the LMF 166. The UE 708 may be an example of the UE 104, the UE 350, the UE 404, or the remote UE 504. The repeater 710 may be an example of the repeater 506. The repeater 710 may include a mobile termination node 712 and a forwarding node 714. The mobile termination node 712 may be an example of the mobile termination node 512, the first mobile termination node 612A or the second mobile termination node 612B. The forwarding node 714 may be an example of the forwarding node 514. Although aspects are described for the network node 702, the aspects may be performed by the network node 702 in aggregation and/or by one or more components of the network node 702 (e.g., such as a CU 110, a DU 130, and/or an RU 140). As shown in FIG. 7, at 716, in an aspect in which the mobile termination node 712 and the forwarding node 714 are co-located, the mobile termination node 712 may provide an ID of the mobile termination node 712 to the network node 702. At 718, the network node 702 may provide the ID of the mobile termination node 712 to the LMF 704.

In some aspects, the ID of the mobile termination node 712 is a GPSI.

At 720, in an aspect in which the mobile termination node 712 and the forwarding node 714 are co-located, the LMF 704 may provide a request for location information indicative of a location of the mobile termination node 712 based the ID of the mobile termination node 712 received at 718. As shown in FIG. 7, the request may be provided to the mobile termination node 712. Alternatively, the request may be provided to another network entity (e.g., another LMF) that has access to and/or stores the location information. At 722, the LMF 704 may receive the location information, for example, by the mobile termination node 712 (or the other network entity). The location information may be indicative of both the location of the mobile termination node 712 and the forwarding node 714, as the mobile termination node 712 and the forwarding node 714 are co-located.

At 724, in an aspect in which the mobile termination node 712 and the forwarding node 714 are not co-located, the OAM node 706 may provide, to the LMF 704, an indication that indicates that the mobile termination node 712 and the forwarding node 714 are not co-located. At 726, the OAM node 706 may also provide, to the LMF 704, location information indicative of the location of the forwarding node 714 and an orientation of at least one antenna of the forwarding node 714.

At 725, the LMF 704 may obtain an indication of whether the mobile termination node 712 and the forwarding node 714 are co-located. In some aspects, the LMF 704 may determine that the mobile termination node 712 and the forwarding node 714 are co-located based on receiving the ID at 718 (e.g., in an aspect in which the mobile termination node 712 and the forwarding node 714 are co-located). In some aspects, the LMF 704 may obtain an indication of whether the mobile termination node 712 and the forwarding node 714 are co-located based on the indication received at 724 (e.g., in an aspect in which the mobile termination node 712 and the forwarding node 714 are not co-located). In some aspects, the LMF 704 may store an indication that the mobile termination node 712 and the forwarding node 714 are co-located, for example, in a memory or cache of the LMF 704 (e.g., in aspects in which the mobile termination node 712 and the forwarding node 714 are either co-located or not co-located).

In some aspects, at 728, the LMF 704 may receive, from the mobile termination node 712, information indicative that there is an LoS between the repeater 710 (e.g., the forwarding node 714 of the repeater 710) and the network node 702, and the LMF 704 may identify that there is an LOS between the repeater 710 and the network node 702 based on the information.

In some aspects, at 730, the LMF 704 may receive, from the mobile termination node 712, a set of RTT measurements between the repeater 710 and the network node 702.

In some aspects, at 732, the LMF 704 may receive information indicative of a BH propagation delay between the repeater 710 and the network node 702. As shown in FIG. 7, the information may be received from the network node 702. However, the information may be received from the mobile termination node 712 in addition or in lieu of receiving the BH propagation delay from the network node 702.

In some aspects, at 734, the LMF 704 may receive, from the mobile termination node 712, information indication of an internal delay of the repeater 710.

At 736, the LMF 704 may obtain timing information associated with the repeater 710. In some aspects, timing information includes at least one of the BH propagation delay between the repeater 710 and the network node 702 or the internal delay of the repeater 710.

In some aspects, the LMF 704 may obtain the BH propagation delay and the internal delay from the network node 702 (at 732) and the mobile termination node 712 (at 734), respectively, as described above. In other aspects, the LMF 704 may calculate the BH propagation delay.

For example, in some aspects, the LMF 704 may calculate the BH propagation delay based on the indication received at 728 indicating that there is an LoS between the repeater 710 and the network node 702. The BH propagation delay may be calculated based on a location of the network node 702 and the location of the forwarding node 714 of the repeater 710 (e.g., as indicated at 722 and/or 724).

In another example, in some aspects, the LMF 704 may calculate the BH propagation delay based on the RTT measurements received at 730.

In some aspects, the timing information obtained by the LMF 704 may include a TEG ID associated with a TEG. The TEG ID may indicate a mean error representative of at least one of the BH propagation delay, the internal delay, or a combination thereof. The TEG identifier may be received in addition to or in lieu of the information received at 734.

At 738, the LMF 704 may provide, to the network node 702, a request to transmit a set of reference signals for a positioning session based on the location information received at 722 and/or 726 and the timing information obtained at 736.

At 740, the network node 702 may transmit the set of reference signals to the forwarding node 714 of the repeater 710, and the forwarding node 714, at 742, may transmit (e.g., forward) the set of reference signals to the UE 708.

At 744, the LMF 704 may provide, to the UE 708, a request to perform a set of measurements (e.g., based on the set of reference signals received at 742) for the positioning session based on the location information received at 722 and/or 726 and the timing information obtained at 736.

At 746, the UE 708 may perform the set of measurements, for example, based on the set of reference signals received at 742.

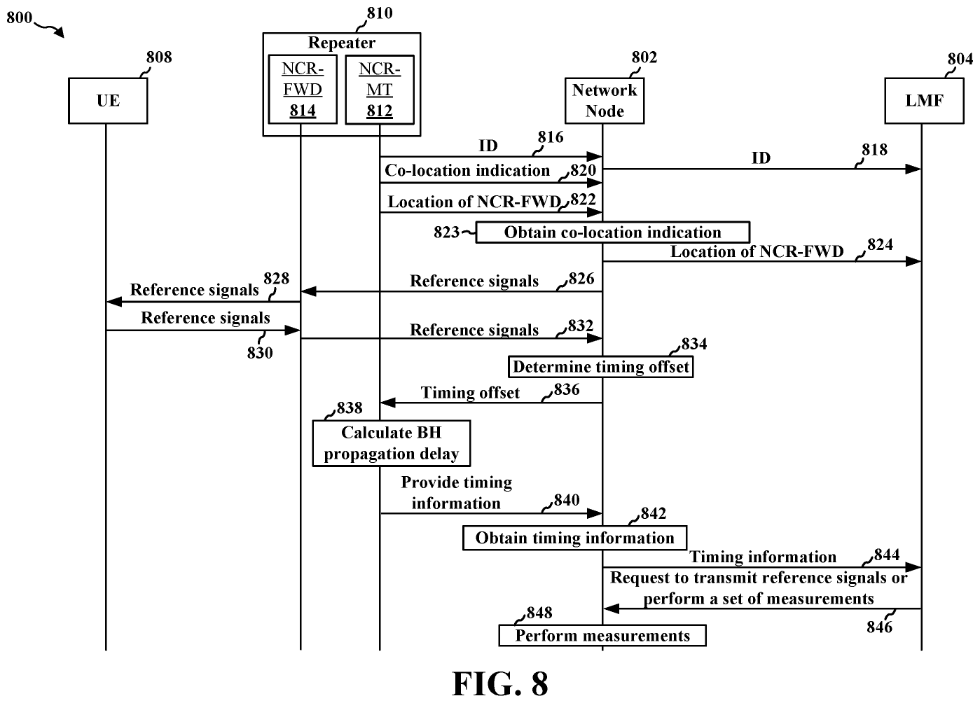

FIG. 8 is a call flow diagram illustrating a method of wireless communication in accordance with various aspects of the present disclosure. As shown in FIG. 8, the diagram 800 includes a network node 802, an LMF 804, a UE 808, and a repeater 810. The network node 802 may be an example of the base station 102, the base station 310, the TRP 402, the TRP 406, the network node 502, or the network node 702. The LMF 804 may be an example of the LMF 166, or the LMF 704. The UE 808 may be an example of the UE 104, the UE 350, the UE 404, the remote UE 504, or the UE 708. The repeater 810 may be an example of the repeater 506 or the repeater 710. The repeater 810 may include a mobile termination node 812 and a forwarding node 814. The mobile termination node 812 may be an example of the mobile termination node 512, the first mobile termination node 612A, the second mobile termination node 612B, or the mobile termination node 712. The forwarding node 814 may be an example of the forwarding node 514 or the forwarding node 714. Although aspects are described for the network node 802, the aspects may be performed by the network node 802 in aggregation and/or by one or more components of the network node 802 (e.g., such as a CU 110, a DU 130, and/or an RU 140). As shown in FIG. 8, at 816, in an aspect in which the mobile termination node 812 and the forwarding node 814 are co-located, the mobile termination node 812 may provide an ID of the mobile termination node 812 to the network node 802. At 818, the network node 802 may provide the ID of the mobile termination node 812 to the LMF 804. The LMF 804 may determine that the mobile termination node 812 and the forwarding node 814 are co-located based on receiving the ID at 818. In some aspects, the LMF 804 may store an indication that the mobile termination node 812 and the forwarding node 814 are co-located, for example, in a memory or cache of the LMF 804.

In some aspects, the ID of the mobile termination node 812 is a GPSI.

In some aspects, the ID of the mobile termination node 812 may be received by the network node 802 via one of a MAC-CE or RRC signaling.

At 820, in an aspect in which the mobile termination node 812 and the forwarding node 714 are not co-located, the mobile termination node 812 may provide, to the network node 802, an indication that indicates that the mobile termination node 812 and the forwarding node 814 are not co-located. At 822, the mobile termination node 812 may also provide, to the network node 802, location information indicative of the location of the forwarding node 814 and an orientation of at least one antenna of the forwarding node 814. It is noted that in some aspects, the indication that indicates that the mobile termination node 812 and the forwarding node 814 are not co-located and/or the location information indicative of the location of the forwarding node 814 and an orientation of at least one antenna of the forwarding node 814 may be received from an OAM node (e.g., the OAM node 706) in addition or in lieu of receiving the indication and the location information from the mobile termination node 812.

At 823, the network node 802 may obtain an indication of whether the mobile termination node 812 and the forwarding node 814 are co-located. In some aspects, the network node 802 may obtain an indication of whether the mobile termination node 812 and the forwarding node 814 are co-located based on the indication received at 820 (e.g., in an aspect in which the mobile termination node 712 and the forwarding node 714 are not co-located). In some aspects, the network node 802 may store an indication that the mobile termination node 812 and the forwarding node 814 are co-located, for example, in a memory or cache of the network node 802 (e.g., in some aspects in which the mobile termination node 812 and the forwarding node 814 are either co-located or not co-located).

At 824, the network node 802 may provide the location information indication of the location of the forwarding node 814 to the LMF 804.

At 826, the network node 802 may transmit a set of reference signals to the forwarding node 814 of the repeater 810, and the forwarding node 814, at 828, may transmit (e.g., forward) the set of reference signals to the UE 708.

At 830, the UE 808 may transmit a set of reference signals to the forwarding node 814 of the repeater 810, and the forwarding node 814, at 832, may transmit (e.g., forward) the set of reference signals to the network node 802.

In some aspects, at 834, the network node 802 may determine (e.g., calculate) a timing offset based on the set of reference signals transmitted by the network node 802 at 824 and the set of reference signals received by the network node 802 at 826. At 836, the network node 802 may provide the timing offset to the mobile termination node 812. At 838, the mobile termination node 812 may calculate an estimated BH propagation delay based on the timing offset. At 840, the mobile termination node 812 may provide the estimated BH propagation delay to the network node 802.

In some aspects, at 840, the network node 802 may receive, from the mobile termination node 812, an error margin indicative of a confidence level of the estimated BH propagation delay.

In some aspects, at 840, the network node 802 may receive, from the mobile termination node 812, information indicative of an internal delay of the repeater 810.

At 842, the network node 802 may obtain timing information associated with the repeater 810.

In some aspects, the timing information may include at least one of a BH propagation delay between the repeater 810 and the network node 802, the error margin indicative of the confidence level of the estimated BH propagation delay, and/or the internal delay of the repeater 810.

For example, at 842, the network node 802 may obtain the BH propagation delay between the repeater 810 and the network node 802, the error margin indicative of the confidence level of the estimated BH propagation delay, and/or the internal delay of the repeater 810 from the mobile termination node 812 at 840. In another example, rather than providing the timing offset to the mobile termination node 812 at 836 and receiving an estimated BH propagation delay from the mobile termination node 812 at 840, the network node, at 842, may calculate the BH propagation delay based on the timing offset determined at 836 and/or determine the error margin indicative of the confidence level of the estimated BH propagation delay.

At 844, the network node 802 may provide the estimated BH propagation delay (if provided by the mobile termination node 812) or the calculated BH propagation delay (if determined by the network node 802), and the information indicative of the internal delay to the LMF 804.

In some aspects, the timing information includes a TEG ID associated with a TEG, and indicates a mean error representative of at least one of the backhaul propagation delay, the internal delay, or a combination thereof. For example, referring to FIG. 8, the timing information received by the network node 802 at 840 and/or provided to the LMF 804 at 844 may include a TEG identifier associated with a TEG. The TEG identifier may indicate a mean error representative of at least one of the BH propagation delay, the internal delay, or a combination thereof. The TEG identifier may be received in addition to or in lieu of the information received at 840.

At 846, the network node 802 may receive a request, from the LMF 804, to transmit a set of reference signals or perform a set of measurements (e.g., uplink measurements) for a positioning session based on the location information and the timing information.

For example, the network node 802 may transmit a set of reference signals in a similar manner described with respect to 826 and, at 848, perform a set of measurements based on a set of reference signals transmitted by the UE 808 and received by the network node 802.

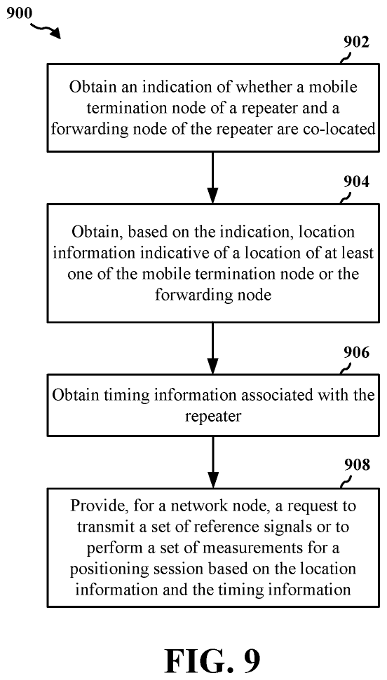

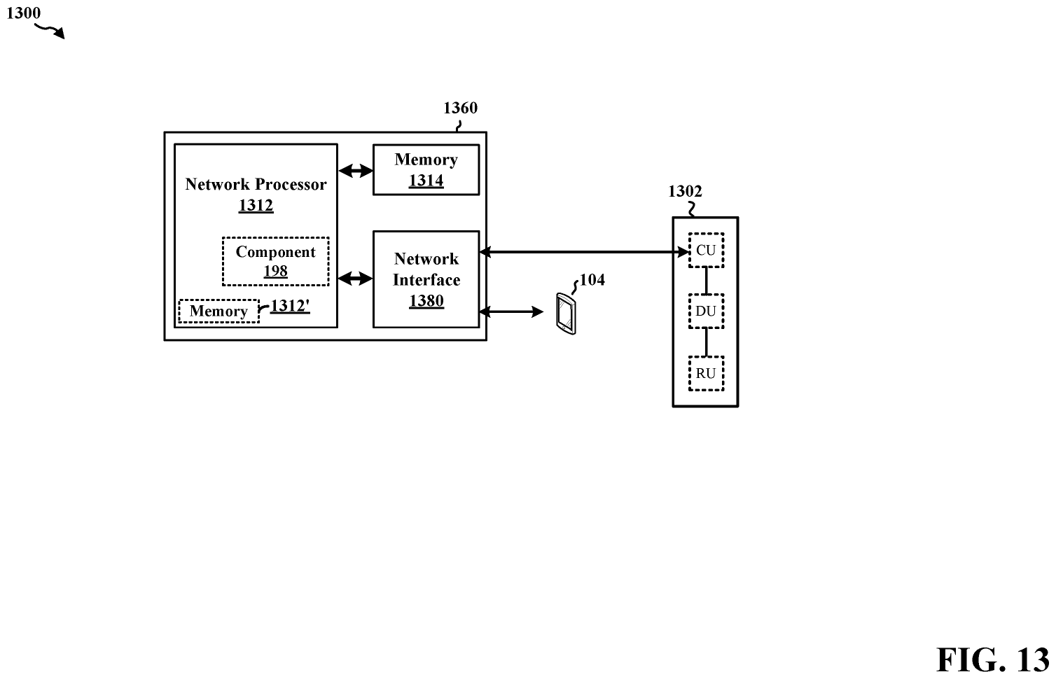

FIG. 9 is a flowchart 900 illustrating methods of wireless communication at a first network entity in accordance with various aspects of the present disclosure. In some aspects, the network entity may be the LMF 166, the LMF 704, or the LMF 804, or the network entity 1360 in the hardware implementation of FIG. 13.

At 902, the first network entity may obtain an indication of whether a mobile termination node of a repeater and a forwarding node of the repeater are co-located. For example, referring to FIG. 7, the LMF 704, at 725, may obtain an indication of whether the mobile termination node 712 and the forwarding node 714 are co-located. In an aspect, 902 may be performed by the timing-based positioning component 198.

In some aspects, the first network entity may obtain the indication by obtaining, from a memory or a cache of the first network entity, the indication, where the indication indicates that the mobile termination node and the forwarding node are co-located. For example, referring to FIG. 7, the LMF 704, at 725, may obtain the indication by obtaining, from a memory or a cache of the LMF 704, the indication, where the indication indicates that the mobile termination node 712 and the forwarding node 714 are co-located.

In some aspects, the first network entity may obtain the indication by receiving, from a second network entity, the indication, where the indication indicates that the mobile termination node and the forwarding node are not co-located. For example, referring to FIG. 7, the LMF 704 may obtain the indication by receiving, from the OAM node 706 at 724, the indication that indicates that the mobile termination node 712 and the forwarding node 714.

At 904, the first network entity may obtain, based on the indication, location information indicative of a location of at least one of the mobile termination node or the forwarding node. For example, referring to FIG. 7, the LMF 704, at 722, may obtain, based on the indication, location information indication of a location of the mobile termination node 712 or, at 726, may obtain, based on the indication, location information indication of a location of the forwarding node 714. In an aspect, 904 may be performed by the timing-based positioning component 198.

In an aspect in which the mobile termination node and the forwarding node are co-located, the first network entity may obtain the location information by obtaining, based on the indication indicating that the mobile termination node and the forwarding node are co-located, an ID of the mobile termination node, providing a request for the location information based on the ID of the mobile termination node, and receiving the location information of the mobile termination node, where the location information is indicative of the location of the mobile termination node and the forwarding node. For example, referring to FIG. 7, in an aspect in which the mobile termination node 712 and the forwarding node 714 are co-located, the LMF 704 may obtain the location information by obtaining, based on the indication (obtained at 725) indicating that the mobile termination node 712 and the forwarding node 714 are co-located, an ID of the mobile termination node 712, providing, at 720, a request for the location information based on the ID of the mobile termination node 712, and, at 722, receiving the location information of the mobile termination node 712, where the location information is indicative of the location of the mobile termination node 712 and the forwarding node 714.

In some aspects, the first network entity may obtain the ID of the mobile termination node by receiving, from the network node, the ID of the mobile termination node. For example, referring to FIG. 7, the LMF 704 may obtain the ID of the mobile termination node 712 by receiving, at 718 from the network node 702, the ID of the mobile termination node 712.

In some aspects, the ID of the mobile termination node includes a GPSI. For example, referring to FIG. 7, the ID received at 718 includes a GPSI.

In an aspect in which the mobile termination node and the forwarding node are not co-located, the first network entity may obtain the location information by receiving, from the second network entity, the location information, where the location information is indicative of the location of the forwarding node and an orientation of at least one antenna of the forwarding node. For example, referring to FIG. 7, in an aspect in which the mobile termination node 712 and the forwarding node 714 are not co-located, the LMF 704 may obtain the location information by receiving, at 726 from the OAM node 706, the location information, where the location information is indicative of the location of the forwarding node 714 and an orientation of at least one antenna of the forwarding node 714.

At 906, the first network entity may obtain timing information associated with the repeater. For example, referring to FIG. 7, the LMF 704, at 736, may obtain timing information associated with the repeater 710. In an aspect, 906 may be performed by the timing-based positioning component 198.

In some aspects, the timing information include at least one of a BH propagation delay between the repeater and the network node or an internal delay of the repeater. For example, referring to FIG. 7, the timing information obtained at 736 may include at least one of a BH propagation delay between the repeater 710 and the network node 702 or an internal delay of the repeater 710.

In some aspects, the first network entity may obtain the timing information by identifying that there is an LoS between the repeater and the network node and calculating, based on identifying that there is the LoS between the repeater and the network node, the BH propagation delay based on a location of the network node and the location information. For example, referring to FIG. 7, the LMF 804 may obtain the timing information by identifying that there is an LoS between the repeater 710 and the network node 702 and calculated, based on identifying that there is the LoS between the repeater 710 and the network node 702, the BH propagation delay based on a location of the network node 802 and the location information obtained at 722 and/or 726.

In some aspects, the first network entity may identify that there is the LoS between the repeater and the network node by receiving, from the mobile termination node, information indicative that there is the LoS between the repeater and the network node. For example, referring to FIG. 7, the LMF 704 may identity that there is the LoS between repeater 710 and the network node 702 by receiving, at 728 from the mobile termination node 712, information indicative that there is the LoS between the repeater 710 and the network node 702.

In some aspects, the first network entity may obtain the timing information by receiving a set of RTT measurements between the repeater and the network node and calculating the BH propagation delay based on the set of RTT measurements. For example, referring to FIG. 7, the LMF 704 may obtain the timing information by receiving, at 730 from the mobile termination node 712, a set of RTT measurements between the repeater 710 and the network node 702 and calculating the BH propagation delay based on the set of RTT measurements.

In some aspects, the first network entity may obtain the timing information by receiving information indicative of the BH propagation delay from at least one of the mobile termination node or the network node. For example, referring to FIG. 7, the LMF 704 may obtain the timing information by receiving, at 732 from at least one of the mobile termination node 712 (as shown in FIG. 7) or the network node 702.

In some aspects, the first network entity may obtain the timing information by receiving, from the mobile termination node, information indicative of the internal delay. For example, referring to FIG. 7, the LMF 704 may obtain the timing information by receiving, at 734 from the mobile termination node 712, information indicative of the internal delay of the repeater 710.

In some aspects, the timing information may include a TEG ID associated with a TEG, and indicates a mean error representative of at least one of the BH propagation delay, the internal delay, or a combination thereof. For example, referring to FIG. 7, the timing information obtained at 736 may include a TEG ID associated with a TEG, and indicates a mean error representative of at least one of the BH propagation delay, the internal delay, or a combination thereof. For example, LMF 704 may receive the TEG ID from the mobile termination node 712 at 734.

At 908, the first network entity may provide, for a network node, a request to transmit a set of reference signals or to perform a set of measurements for a positioning session based on the location information and the timing information. For example, referring to FIG. 7, the LMF 704, at 738, may provide, for the network node 702, a request to transmit a set of reference signals for a positioning session or, at 744, may provide, for the UE 708, a request to perform a set of measurements for the positioning session based on the location information and the timing information. In an aspect, 908 may be performed by the timing-based positioning component 198.

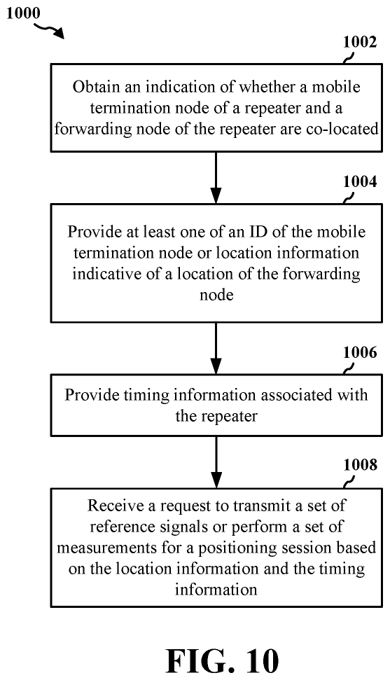

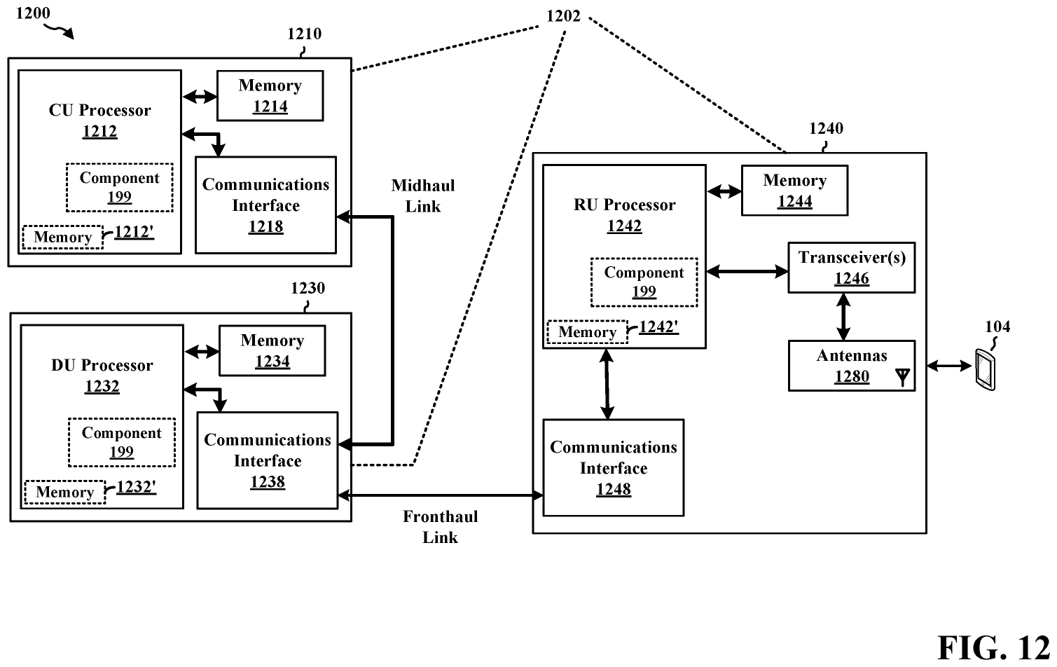

FIG. 10 is a flowchart 1000 illustrating methods of wireless communication at a first network node in accordance with various aspects of the present disclosure. In some aspects, the network node may be an example of the base station 102, the base station 310, the TRP 402, the TRP 406, or the network node 502, the network node 702, or the network node 802, or the network entity 1202 in the hardware implementation of FIG. 12.

At 1002, the first network entity may obtain an indication of whether a mobile termination node of a repeater and a forwarding node of the repeater are co-located. For example, referring to FIG. 8, the LMF 804, at 823, may obtain an indication of whether the mobile termination node 812 and the forwarding node 814 are co-located. In an aspect, 1002 may be performed by the timing-based positioning component 199.

In some aspects, the network node may obtain the indication by obtaining, from a memory or a cache of the network node, the indication, where the indication indicates that the mobile termination node and the forwarding node are co-located. For example, referring to FIG. 8, the network node 802 may obtain the indication by obtaining, at 823, from a memory or a cache of the network node 802, the indication, where the indication indicates that the mobile termination node 812 and the forwarding node 814 are co-located.

In some aspects, the network node may obtain the indication by receiving, from the mobile termination node, the indication, where the indication indicates that the mobile termination node and the forwarding node are not co-located. For example, referring to FIG. 8, the network node 802 may obtain the indication by receiving, at 820 from the mobile termination node 812, the indication, where the indication indicates that the mobile termination node 812 and the forwarding node 814 are not co-located.

At 1004, the network node may provide at least one of an ID of the mobile termination node or location information indicative of a location of the forwarding node. For example, referring to FIG. 8, the network node 802 may provide at least one of an ID of the mobile termination node 812 (at 818) or location information indicative of a location of the forwarding node 814 (at 824). In an aspect, 1004 may be performed by the timing-based positioning component 199.

In some aspects, the network node may provide at least one of the ID of the mobile termination node or the location information indicative of the location of the forwarding node by obtaining the ID of the mobile termination node and providing, for a network entity, the identifier of the mobile termination node. For example, referring to FIG. 8, the network node 802 may provide at least one of the ID of the mobile termination node 812 or the location information indicative of the location of the forwarding node 814 by obtaining, at 816, the ID of the mobile termination node 812 (e.g., from the mobile termination node 812, as shown in FIG. 8) and providing, at 818 for the LMF 804, the ID of the mobile termination node 812.

In some aspects, the ID of the mobile termination node includes a GPSI. For example, referring to FIG. 8, the ID of the mobile termination node 812 obtained at 816 and provided at 818 may include a GPSI.

In some aspects, the network node may obtain the ID of the mobile termination node by receiving, from the mobile termination node, the ID of the mobile termination node via one of a MAC-CE or RRC signaling. For example, referring to FIG. 8, the network node 802 may obtain the ID of the mobile termination node 812 at 816 via one of a MAC-CE or RRC signaling.

In some aspects, the network node may provide at least one of the ID of the mobile termination node or the location information indicative of the location of the forwarding node by receiving, from the mobile termination node of the repeater, the location information indicative of the location of the forwarding node, where the location information is further indicative of an orientation of at least one antenna of the forwarding node and providing, for a network entity, the location information. For example, referring to FIG. 8, the network node 802 may provide at least one of the ID of the mobile termination node 812 or the location information indicative of the location of the forwarding node 814 by receiving, at 822 from the mobile termination node 812 of the repeater 810, the location information indicative of the location of the forwarding node 814, where the location information is further indicative of an orientation of at least one antenna of the forwarding node 814 and providing, at 824 for the LMF 804, the location information.

At 1006, the network node may provide timing information associated with the repeater. For example, referring to FIG. 8, the network node 1002, at 840, may provide timing information associated with the repeater 810. In an aspect, 1006 may be performed by the timing-based positioning component 199.

In some aspects, the timing information may include at least one of a BH propagation delay between the repeater and the network node or an internal delay of the repeater. For example, referring to FIG. 8, the timing information received at 840 may include at least one of a BH propagation delay between the repeater 810 and the network node 802 or an internal delay of the repeater 810.

In some aspects, the network node may provide the timing information by calculating the BH propagation delay based on a timing offset of a first reference signal transmitted by the network node and a second reference signal received by the network node and providing, for a network entity, the calculated BH propagation delay. For example, referring to FIG. 8, the network node 802 may provide the timing information by calculating, at 838, the BH propagation delay based on a timing offset of a first reference signal transmitted by the network node 802 (at 826) and a second reference signal received by the network node 802 (at 832) and providing, at 844 for the LMF 804, the calculated BH propagation delay.

In some aspects, the network node may provide the timing information by calculating a timing offset of a first reference signal transmitted by the network node and a second reference signal received by the network node, providing, for the mobile termination node, the timing offset, receiving, from the mobile termination node, an estimated BH propagation delay that is based on the timing offset, and providing, for a network entity, the estimated BH propagation delay. For example, referring to FIG. 8, the network node 802 may provide the timing information by calculated, at 834, a timing offset of a first reference signal transmitted by the network node 802 (at 826) and a second reference signal received by the network node 802 (at 832), providing, at 836 for the mobile termination node 812, the timing offset, receiving, at 840 from the mobile termination node 812, an estimated BH propagation delay that is based on the timing offset, and providing, at 844 for the LMF 804, the estimated BH propagation delay.

In some aspects, the network node may receive, from the mobile termination node, an error margin indicative of a confidence level of the estimated BH propagation delay. For example, referring to FIG. 8, the network node 802 may, at 840 from the mobile termination node 812, an error margin that may indicate of a confidence level of the estimated BH propagation delay.

In some aspects, the network node may provide the timing information by receiving, from the mobile termination node, information indicative of the internal delay and providing, for a network entity, the information indicative of the internal delay. For example, referring to FIG. 8, the network node 802 may provide the timing information by receiving, at 840 from the mobile termination node 812, information indicative of the internal delay of the repeater 810 and providing, for the LMF 804, the information indicative of the internal delay.

In some aspects, the timing information may include a TEG ID associated with a TEG, and indicates a mean error representative of at least one of the BH propagation delay, the internal delay, or a combination thereof. For example, referring to FIG. 8, the timing information obtained at 842 may include a TEG ID associated with a TEG, and indicates a mean error representative of at least one of the BH propagation delay, the internal delay, or a combination thereof. For example, LMF 804 may receive the TEG ID from the mobile termination node 812 at 840.

At 1008, the network node may receive a request to transmit a set of reference signals or perform a set of measurements for a positioning session based on the location information and the timing information. For example, referring to FIG. 8, the network node 802, at 846, may receive, from the LMF 804, a request to transmit a set of reference signals or perform a set of measurements for a positioning session based on the location information and the timing information. In an aspect, 1008 may be performed by the timing-based positioning component 199.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104, the core network 120, and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see UE 350 of FIG. 3) and include the additional modules of the apparatus 1104.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to obtain an indication of whether a mobile termination node of a repeater and a forwarding node of the repeater are co-located, provide at least one of an ID of the mobile termination node or location information indicative of a location of the forwarding node, provide timing information associated with the repeater, and receive a request to transmit a set of reference signals or perform a set of measurements for a positioning session based on the location information and the timing information. The component 199 may be configured to perform any of the aspects described in connection with the flowchart in FIG. 10 and/or the aspects performed by the network node 802 in the communication flow in FIG. 8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 may include means for obtaining an indication of whether a mobile termination node of a repeater and a forwarding node of the repeater are co-located, means for providing at least one of an ID of the mobile termination node or location information indicative of a location of the forwarding node, means for providing timing information associated with the repeater, and means for receiving a request to transmit a set of reference signals or perform a set of measurements for a positioning session based on the location information and the timing information. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a RIC) with the CU 1302 and the UE 104. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to obtain an indication of whether a mobile termination node of a repeater and a forwarding node of the repeater are co-located, obtain, based on the indication, location information indicative of a location of at least one of the mobile termination node or the forwarding node, obtain timing information associated with the repeater, and provide, for a network node, a request to transmit a set of reference signals or to perform a set of measurements for a positioning session based on the location information and the timing information. The component 198 may be configured to perform any of the aspects described in connection with the flowchart in FIG. 9 and/or the aspects performed by the LMF 704 in the communication flow in FIG. 7 The component 198 may be within the processor 1312. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 may include means for obtaining an indication of whether a mobile termination node of a repeater and a forwarding node of the repeater are co-located, means for obtaining, based on the indication, location information indicative of a location of at least one of the mobile termination node or the forwarding node, means for obtaining timing information associated with the repeater, and means for providing, for a network node, a request to transmit a set of reference signals or to perform a set of measurements for a positioning session based on the location information and the timing information. The means may be the component 198 of the network entity 1360 configured to perform the functions recited by the means.

Various aspects relate generally to positioning systems. Some aspects more specifically relate to timing-based positioning based on reference signals transmitted by a repeater. In some examples, a network entity (e.g., a location management function (LMF)) may obtain location information associated with a repeater (e.g., the location of a mobile termination node and/or a forwarding node of the repeater). The network entity may also obtain timing information associated with the repeater (e.g., a backhaul propagation delay and/or an internal delay of the repeater). The network entity may, based on the location information and the timing information, provide a request (e.g., to the network node) to transmit a set of reference signals or a request (e.g., to a UE) to perform a set of measurements for a positioning session.

Particular aspects of the subject matter described in this disclosure can be implemented to realize one or more of the following potential advantages. In some examples, by considering the location and timing information of a repeater when performing the positioning session, a more accurate positioning result or state (e.g., the location, heading, and/or velocity) of a target entity may be determined.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B. A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, including: obtaining an indication of whether a mobile termination node of a repeater and a forwarding node of the repeater are co-located; obtaining, based on the indication, location information indicative of a location of at least one of the mobile termination node or the forwarding node; obtaining timing information associated with the repeater; and providing for a network node, a request to transmit a set of reference signals or to perform a set of measurements for a positioning session based on the location information and the timing information.

Aspect 2 is the method of aspect 1, where obtaining the indication includes: obtaining, from a first memory or a cache of the first network entity, the indication, where the indication indicates that the mobile termination node and the forwarding node are co-located.

Aspect 3 is the method of aspect 2, where obtaining the location information includes: obtaining, based on the indication indicating that the mobile termination node and the forwarding node are co-located, an ID of the mobile termination node; providing a request for the location information based on the ID of the mobile termination node; and receiving the location information of the mobile termination node, where the location information is indicative of the location of the mobile termination node and the forwarding node.

Aspect 4 is the method of aspect 3, where obtaining the ID of the mobile termination node includes: receiving, from the network node, the ID of the mobile termination node.

Aspect 5 is the method of claim 3, where the ID of the mobile termination node includes a GPSI.

Aspect 6 is the method of any of aspects 1 and 3 to 5, where obtaining the indication includes: receiving, from a second network entity, the indication, where the indication indicates that the mobile termination node and the forwarding node are not co-located.

Aspect 7 is the method of aspect 6, where obtaining the location information includes: receiving, from the second network entity, the location information, where the location information is indicative of the location of the forwarding node and an orientation of at least one antenna of the forwarding node.

Aspect 8 is the method of any of aspects 1 to 7, where the timing information includes at least one of a BH propagation delay between the repeater and the network node; or an internal delay of the repeater.

Aspect 9 is the method of aspect 8, where obtaining the timing information includes: identifying that there is an LoS between the repeater and the network node; and calculating, based on the identification that there is the LoS between the repeater and the network node, the BH propagation delay based on a location of the network node and the location information.

Aspect 10 is the method of aspect 9, where identifying that there is the LoS between the repeater and the network node includes: receiving, from the mobile termination node, information indicative that there is the LoS between the repeater and the network node.

Aspect 11 is the method of aspect 8, where obtaining the timing information includes: receiving a set of RTT measurements between the repeater and the network node; and calculating the BH propagation delay based on the set of RTT measurements.

Aspect 12 is the method of aspect 8, where obtaining the timing information includes: receiving information indicative of the BH propagation delay from at least one of the mobile termination node or the network node.

Aspect 13 is the method of any of aspects 8 to 12, where obtaining the timing information includes: receiving, from the mobile termination node, information indicative of the internal delay.

Aspect 14 is the method of aspect 8, where the timing information includes a TEG identifier associated with a TEG, and indicates a mean error representative of at least one of the BH propagation delay, the internal delay, or a combination thereof.

Aspect 15 is a method of wireless communication at a network node, including: obtaining an indication of whether a mobile termination node of a repeater and a forwarding node of the repeater are co-located; providing at least one of an ID of the mobile termination node or location information indicative of a location of the forwarding node; providing timing information associated with the repeater; and receiving a request to transmit a set of reference signals or perform a set of measurements for a positioning session based on the location information and the timing information.

Aspect 16 is the method of aspect 15, where obtaining the indication includes: obtaining, from a first memory or a cache of the network node, the indication, where the indication indicates that the mobile termination node and the forwarding node are co-located.

Aspect 17 is the method of any of aspects 15 and 16, where providing at least one of the ID of the mobile termination node or the location information indicative of the location of the forwarding node includes: obtaining the ID of the mobile termination node; and providing, for a network entity, the identifier of the mobile termination node.

Aspect 18 is the method of aspect 17, where the ID of the mobile termination node includes a GPSI.

Aspect 19 is the method of any of aspects 15 to 18, where obtaining the ID of the mobile termination node includes: receiving, from the mobile termination node, the ID of the mobile termination node via one of a MAC-CE or RRC signaling.

Aspect 20 is the method of any of aspects 15 and 17 to 19, where obtaining the indication includes: receiving, from the mobile termination node, the indication, where the indication indicates that the mobile termination node and the forwarding node are not co-located.

Aspect 21 is the method of aspect 20, where providing at least one of the ID of the mobile termination node or the location information indicative of the location of the forwarding node includes: receiving, from the mobile termination node of the repeater, the location information indicative of the location of the forwarding node, where the location information is further indicative of an orientation of at least one antenna of the forwarding node; and providing, for a network entity, the location information.

Aspect 22 is the method of any of aspects 15 to 21, where the timing information includes at least one of: a BH propagation delay between the repeater and the network node; and an internal delay of the repeater.

Aspect 23 is the method of aspect 22, where providing the timing information includes: calculating the BH propagation delay based on a timing offset of a first reference signal transmitted by the network node and a second reference signal received by the network node; and providing, for a network entity, the calculated BH propagation delay.

Aspect 24 is the method of aspect 22, where providing the timing information includes: calculating a timing offset of a first reference signal transmitted by the network node and a second reference signal received by the network node; providing, for the mobile termination node, the timing offset; receiving, from the mobile termination node, an estimated BH propagation delay that is based on the timing offset; and providing, for a network entity, the estimated BH propagation delay.

Aspect 25 is the method of aspect 24, further including: receiving, from the mobile termination node, an error margin indicative of a confidence level of the estimated BH propagation delay.

Aspect 26 is the method of aspect 22, where providing the timing information includes: receiving, from the mobile termination node, information indicative of the internal delay; and providing, for a network entity, the information indicative of the internal delay.

Aspect 27 is the method of aspect 22, where timing information includes a TEG identifier associated with a TEG, and indicates a mean error representative of at least one of the backhaul propagation delay, the internal delay, or a combination thereof.

Aspect 28 is an apparatus for wireless communication at a first network entity. The apparatus includes memory; and at least one processor coupled to the memory and, based at least in part on information stored in the memory, the at least one processor is configured to implement any of aspects 1 to 14.

Aspect 29 is the apparatus of aspect 28, further including at least one of a transceiver or an antenna coupled to the at least one processor.

Aspect 30 is an apparatus for wireless communication at a network node. The apparatus includes memory; and at least one processor coupled to the memory and, based at least in part on information stored in the memory, the at least one processor is configured to implement any of aspects 15 to 27.

Aspect 31 is the apparatus of aspect 30, further including at least one of a transceiver or an antenna coupled to the at least one processor.

Aspect 32 is an apparatus for wireless communication including means for implementing any of aspects 1 to 14.

Aspect 33 is an apparatus for wireless communication including means for implementing any of aspects 15 to 27.

Aspect 34 is a computer-readable medium (e.g., a non-transitory computer-readable medium) storing computer executable code, where the code when executed by a processor causes the processor to implement any of aspects 1 to 14.

Aspect 35 is a computer-readable medium (e.g., a non-transitory computer-readable medium) storing computer executable code, where the code when executed by a processor causes the processor to implement any of aspects 15 to 27.

What is claimed is:

1. An apparatus for wireless communication at a first network entity, comprising:
a memory; and
at least one processor coupled to the memory and, based at least in part on information stored in the memory, the at least one processor is configured to:
obtain an indication of whether a mobile termination node of a repeater and a forwarding node of the repeater are co-located;
obtain, based on the indication, location information indicative of a location of at least one of the mobile termination node or the forwarding node;
obtain timing information associated with the repeater; and
provide, for a network node, a request to transmit a set of reference signals or to perform a set of measurements for a positioning session based on the location information and the timing information.

2. The apparatus of claim 1, wherein, to obtain the indication, the at least one processor is configured to:
obtain, from a first memory or a cache of the first network entity, the indication, wherein the indication indicates that the mobile termination node and the forwarding node are co-located.

3. The apparatus of claim 2, wherein, to obtain the location information, the at least one processor is configured to:
obtain, based on the indication indicating that the mobile termination node and the forwarding node are co-located, an identifier (ID) of the mobile termination node;
provide a request for the location information based on the ID of the mobile termination node; and
receive the location information of the mobile termination node, wherein the location information is indicative of the location of the mobile termination node and the forwarding node.

4. The apparatus of claim 3, wherein, to obtain the ID of the mobile termination node, the at least one processor is configured to:
receive, from the network node, the ID of the mobile termination node.

5. The apparatus of claim 3, wherein the ID of the mobile termination node comprises a generic public subscription identifier (GPSI).

6. The apparatus of claim 1, wherein, to obtain the indication, the at least one processor is configured to:
receive, from a second network entity, the indication, wherein the indication indicates that the mobile termination node and the forwarding node are not co-located.

7. The apparatus of claim 6, wherein, to obtain the location information, the at least one processor is configured to:
receive, from the second network entity, the location information, wherein the location information is indicative of the location of the forwarding node and an orientation of at least one antenna of the forwarding node.

8. The apparatus of claim 1, wherein the timing information comprises at least one of:
a backhaul propagation delay between the repeater and the network node; or
an internal delay of the repeater.

9. The apparatus of claim 8, wherein, to obtain the timing information, the at least one processor is configured to:
identify that there is a line-of-sight (LoS) between the repeater and the network node; and
calculate, based on the identification that there is the LoS between the repeater and the network node, the backhaul propagation delay based on a location of the network node and the location information.

10. The apparatus of claim 9, wherein, to identify that there is the LoS between the repeater and the network node, the at least one processor is configured to:
receive, from the mobile termination node, information indicative that there is the LoS between the repeater and the network node.

11. The apparatus of claim 8, wherein, to obtain the timing information, the at least one processor is configured to:
receive a set of round-trip time (RTT) measurements between the repeater and the network node; and
calculate the backhaul propagation delay based on the set of RTT measurements.

12. The apparatus of claim 8, wherein, to obtain the timing information, the at least one processor is configured to:
receive information indicative of the backhaul propagation delay from at least one of the mobile termination node or the network node.

13. The apparatus of claim 8, further comprising at least one of a transceiver or an antenna coupled to the at least one processor, wherein, to obtain the timing information, the at least one processor is configured to:
receive, from the mobile termination node via at least one of the transceiver or the antenna, information indicative of the internal delay.

14. The apparatus of claim 8, wherein the timing information comprises a timing error group (TEG) identifier associated with a TEG, and indicates a mean error representative of at least one of the backhaul propagation delay, the internal delay, or a combination thereof.

15. An apparatus for wireless communication at a network node, comprising:
a memory; and
at least one processor coupled to the memory and, based at least in part on information stored in the memory, the at least one processor is configured to:
obtain an indication of whether a mobile termination node of a repeater and a forwarding node of the repeater are co-located;
provide at least one of an identifier (ID) of the mobile termination node or location information indicative of a location of the forwarding node;
provide timing information associated with the repeater; and
receive a request to transmit a set of reference signals or perform a set of measurements for a positioning session based on the location information and the timing information.

16. The apparatus of claim 15, wherein, to obtain the indication, the at least one processor is configured to:
obtain, from a first memory or a cache of the network node, the indication, wherein the indication indicates that the mobile termination node and the forwarding node are co-located.

17. The apparatus of claim 16, wherein, to provide at least one of the ID of the mobile termination node or the location information indicative of the location of the forwarding node, the at least one processor is configured to:
obtain the ID of the mobile termination node; and
provide, for a network entity, the identifier of the mobile termination node.

18. The apparatus of claim 17, wherein the ID of the mobile termination node comprises a generic public subscription identifier (GPSI).

19. The apparatus of claim 17, wherein, to obtain the ID of the mobile termination node, the at least one processor is configured to:
receive, from the mobile termination node, the ID of the mobile termination node via one of a medium access control (MAC) control element (MAC-CE) or radio resource control (RRC) signaling.

20. The apparatus of claim 16, wherein, to obtain the indication, the at least one processor is configured to:
receive, from the mobile termination node, the indication, wherein the indication indicates that the mobile termination node and the forwarding node are not co-located.

21. The apparatus of claim 20, wherein, to provide at least one of the ID of the mobile termination node or the location information indicative of the location of the forwarding node, the at least one processor is configured to:
receive, from the mobile termination node of the repeater, the location information indicative of the location of the forwarding node, wherein the location information is further indicative of an orientation of at least one antenna of the forwarding node; and
provide, for a network entity, the location information.

22. The apparatus of claim 15, wherein the timing information comprises at least one of:
a backhaul propagation delay between the repeater and the network node; or
an internal delay of the repeater.

23. The apparatus of claim 22, wherein, to provide the timing information, the at least one processor is configured to:
calculate the backhaul propagation delay based on a timing offset of a first reference signal transmitted by the network node and a second reference signal received by the network node; and
provide, for a network entity, the calculated backhaul propagation delay.

24. The apparatus of claim 22, wherein, to provide the timing information, the at least one processor is configured to:
calculate a timing offset of a first reference signal transmitted by the network node and a second reference signal received by the network node;
provide, for the mobile termination node, the timing offset;
receive, from the mobile termination node, an estimated backhaul propagation delay that is based on the timing offset; and
provide, for a network entity, the estimated backhaul propagation delay.

25. The apparatus of claim 24, further comprising at least one of a transceiver or an antenna coupled to the at least one processor, wherein the at least one processor is further configured to:
receive, from the mobile termination node via at least one of the transceiver or the antenna, an error margin indicative of a confidence level of the estimated backhaul propagation delay.

26. The apparatus of claim 22, wherein, to provide the timing information, the at least one processor is configured to:
receive, from the mobile termination node, information indicative of the internal delay; and
provide, for a network entity, the information indicative of the internal delay.

27. The apparatus of claim 22, wherein the timing information comprises a timing error group (TEG) identifier associated with a TEG, and indicates a mean error representative of at least one of the backhaul propagation delay, the internal delay, or a combination thereof.

28. A method for wireless communication at a first network entity, comprising:
obtaining an indication of whether a mobile termination node of a repeater and a forwarding node of the repeater are co-located;
obtaining, based on the indication, location information indicative of a location of at least one of the mobile termination node or the forwarding node;
obtaining timing information associated with the repeater; and
providing, for a network node, a request to transmit a set of reference signals or to perform a set of measurements for a positioning session based on the location information and the timing information.

29. The method of claim 28, wherein obtaining the indication comprises:
obtaining, from a memory or a cache of the first network entity, the indication, wherein the indication indicates that the mobile termination node and the forwarding node are co-located.

30. A method for wireless communication at a network node, comprising:
obtaining an indication of whether a mobile termination node of a repeater and a forwarding node of the repeater are co-located;
providing at least one of an identifier (ID) of the mobile termination node or location information indicative of a location of the forwarding node;
providing timing information associated with the repeater; and
receiving a request to transmit a set of reference signals or perform a set of measurements for a positioning session based on the location information and the timing information.
